(19) United States
(12) Patent Application Publication
(10) Pub. No.: US 2022/0371344 A1
(43) Pub. Date: Nov. 24, 2022

(54) PRINTING APPARATUS

(71) Applicant: Roland DG Corporation, Hamamatsu-shi (JP)

(72) Inventors: Yudai CHIDA, Hamamatsu-shi (JP); Kiyoshi FUJIMOTO, Hamamatsu-shi (JP); Kiyomasa IMAIZUMI, Hamamatsu-shi (JP); Hironari OKAMOTO, Hamamatsu-shi (JP); Shinya YAMAMOTO, Hamamatsu-shi (JP); Takayuki MORIKAMI, Hamamatsu-shi (JP); Masaki YOSHIDA, Hamamatsu-shi (JP)

(21) Appl. No.: 17/747,029

(22) Filed: May 18, 2022

(30) Foreign Application Priority Data
May 24, 2021 (JP) 2021-086669

(51) Int. Cl. B41J 23/32; B41J 25/00

(52) U.S. Cl. CPC B41J 23/32; B41J 25/006

(57) ABSTRACT

A printing apparatus includes a carriage, a carriage mover including a motor to move the carriage, a motor controller configured to control the motor, a power supply configured to selectively apply a first voltage or a second voltage to the motor controller, the second voltage being higher than the first voltage, and a transmitter to transmit a control signal for movement of the carriage when a predetermined control condition is satisfied. The first voltage is a voltage enabling the motor controller to move the carriage at a first speed by the motor. The second voltage is a voltage enabling the motor controller to move the carriage at a second speed by the motor, the second speed being higher than the first speed. The power supply applies the first voltage to the motor controller in a state where the transmitter transmits the control signal.

### CROSS REFERENCE TO RELATED APPLICATIONS

This application claims the benefit of priority to Japanese Patent No. 2021-086669 filed on May 24, 2021. The entire contents of this application are hereby incorporated herein by reference.

### BACKGROUND OF THE INVENTION

### 1. Field of the Invention

The present invention relates to a printing apparatus.

### 2. Description of the Related Art

Various types of conventional apparatuses have used an interlock operation of safely stopping the apparatus. A printing apparatus also uses an interlock operation in general. JP 2019-010829 A, for example, discloses a printer in which when a housing is uncovered during printing, movement of a carriage is stopped, and then, energization to a motor that moves the carriage is shut off.

In a printing apparatus as described in JP 2019-010829 A, the carriage cannot be moved under a predetermined condition in which the housing is uncovered, for example. However, under such a condition, there is a need for moving the carriage, for example, a user wants to visually observe movement of the carriage with the cover open, in some cases.

### SUMMARY OF THE INVENTION

A printing apparatus according to a preferred embodiment of the present invention includes a carriage, a carriage mover including a motor to move the carriage, a motor controller to control the motor, a power supply to selectively apply a first voltage or a second voltage to the motor controller, the second voltage being higher than the first voltage, and a transmitter to transmit a control signal for movement of the carriage when a predetermined control condition is satisfied. The first voltage is a voltage enabling the motor controller to move the carriage at a first speed by the motor. The second voltage is a voltage enabling the motor controller to move the carriage at a second speed by the motor. The second speed is higher than the first speed. The power supply applies the first voltage to the motor controller in a state where the transmitter transmits the control signal.

In the printing apparatus, even in a state where the predetermined control condition is satisfied and the transmitter transmits a control signal, the first voltage is applied to the motor controller. Thus, the carriage can be moved at the first speed. Since the first speed is relatively low, movement of the carriage will not cause any safety problems. Thus, the printing apparatus can satisfy both safety and convenience under the predetermined interlock conditions.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of a printer according to a preferred embodiment of the present invention.

FIG. 2 is a front view of the printer in a state where covers are open.

FIG. 3 is a schematic front view of a cleaning device.

FIG. 4 is a circuit diagram concerning control of a carriage motor.

FIG. 5 is a flowchart showing control of a carriage in a high-speed mode.

FIG. 6 is a flowchart showing control of the carriage in a low-speed mode.

### DETAILED DESCRIPTION OF THE PREFERRED EMBODIMENTS

Printers according to preferred embodiments of the present invention will be described with reference to the drawings. The preferred embodiments described here are, of course, not intended to particularly limit the present invention. Elements and features having the same functions are denoted by the same reference numerals, and description for the same elements and features will not be repeated or will be simplified as appropriate. In the following description, when the printer is seen from the front, a direction away from the printer will be referred to as forward, and a direction toward the printer will be referred to as rearward. In the drawings, character Y represents a main scanning direction, and character X represents a subscanning direction X orthogonal to the main scanning direction Y. Characters F, Rr, L, R, U, and D in the drawings represent front, rear, left, right, up, and down, respectively. It should be noted that these directions are defined merely for convenience of description, and do not limit the state of installation, for example, of the printer.

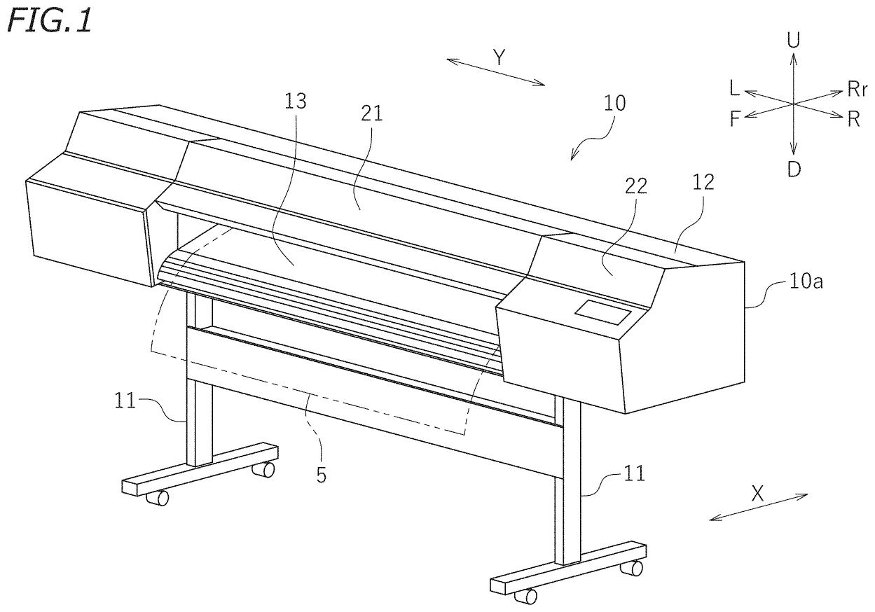

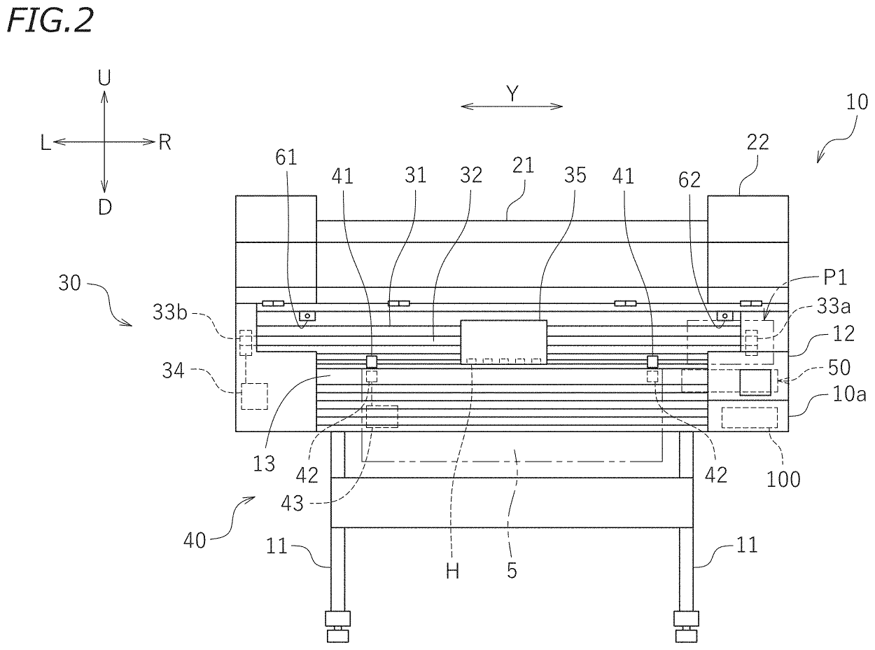

FIG. 1 is a perspective view of a large-size printer 10 according to a preferred embodiment of the present invention. The printer 10 is an ink jet printer that prints an image on a recording medium 5 by sequentially moving the rolled recording medium 5 forward and discharging ink from a plurality of ink heads H (see FIG. 2) mounted on a carriage 35 (see FIG. 2) movable in the main scanning direction Y.

The recording medium 5 is a target on which an image is printed. The recording medium 5 is not limited to a specific medium. The recording medium 5 may be, for example, a paper sheet such as plain paper or ink jet printing paper, a transparent sheet of, for example, a resin or glass, or a sheet of, for example, a metal or rubber. The recording medium 5 may also be a fabric.

As illustrated in FIG. 1, the printer 10 includes a printer body 10a and legs 11 supporting the printer body 10a. The printer body 10a extends in the main scanning direction Y. The printer body 10a includes a casing 12. Main components of the printer 10 including the carriage 35 are housed in the casing 12. The casing 12 is provided with a first cover 21 and a second cover 22. The first cover 21 and the second cover 22 are provided for maintenance of the inside of the casing 12, for example. The first cover 21 and the second cover 22 are attached to the front side of the printer 10, and are configured to be opened and closed in the up-down direction. The position, number, shape, and structure, for example, of the covers are not specifically limited.

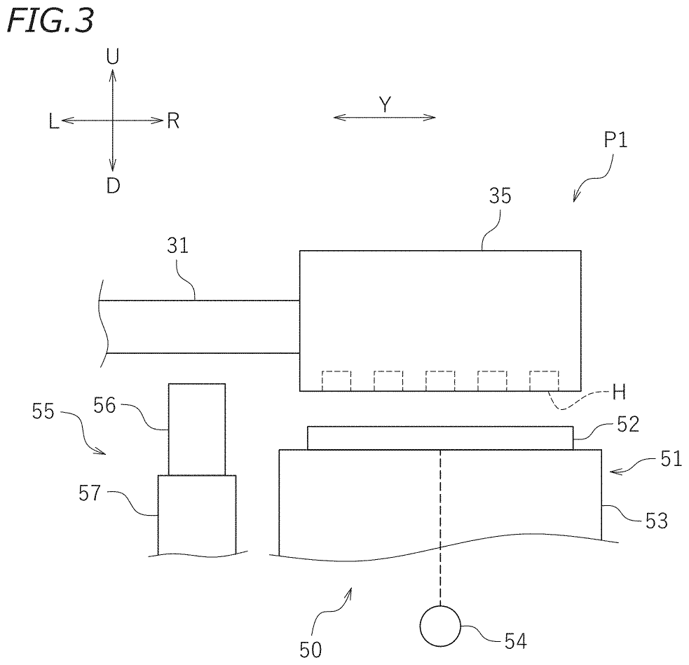

FIG. 2 is a front view of the printer 10 in a state where the first cover 21 and the second cover 22 are open. As illustrated in FIG. 2, the casing 12 houses the carriage 35 and a carriage moving device 30. The casing 12 houses a cleaning device 50 to clean the ink heads H, which are illustrated in FIG. 3 in detail. As illustrated in FIG. 2, the carriage moving device 30 includes a guide rail 31, an endless belt 32, a pair of pulleys 33a and 33b, and a carriage motor 34. The carriage moving device 30 moves the carriage 35 in the main scanning direction Y by driving the carriage motor 34. The guide rail 31 extends in the main scanning direction Y. The carriage 35 is movable in the main scanning direction Y along the guide rail 31. The endless belt 32 is fixed to the carriage 35. The belt 32 is wound around the pulley 33a at the right of the guide rail 31 and the pulley 33b at the left of the guide rail 31. The carriage motor 34 is attached to the left pulley 33b. When the carriage motor 34 is driven, the pulley 33b rotates so that the belt 32 runs. Accordingly, the carriage 35 moves in the main scanning direction Y along the guide rail 31.

The carriage 35 holds the plurality of ink heads H. When the carriage 35 moves in the main scanning direction Y, the ink heads H thereby move in the main scanning direction Y. The ink heads H are arranged in the main scanning direction Y in the carriage 35. Each of the ink heads H includes a plurality of nozzles (not shown) arranged in the subscanning direction X. The nozzles are arranged in the subscanning direction X to provide a nozzle row. The number of nozzles is, for example, 300 in each nozzle row. The number of nozzles belonging to one nozzle row is not limited to a specific number. Each of the ink heads H may include a plurality of nozzle rows. The nozzles in the ink heads H are not limited to a specific arrangement. Actuators (not shown) each including a piezoelectric element are disposed inside the ink heads H. When the actuators are driven, ink is thereby discharged from the nozzles of the ink heads H toward the recording medium 5. The actuator is not limited to a type that is driven by a piezoelectric element.

Each of the ink heads H communicate with a plurality of unillustrated ink cartridges through unillustrated ink supply paths. Each of the ink cartridges is connected to one nozzle row. The nozzles of one nozzle row discharge an ink of the ink cartridge connected to this nozzle row. Each ink cartridge stores an ink of a process color such as CMYK or an ink of a spot color, for example. The color of an ink discharged from the nozzles of each nozzle row is not limited. The inks are not limited to specific materials, either, and various materials conventionally used as ink materials for ink jet printers may be used. Examples of the inks include a solvent-based pigment ink, an aqueous pigment ink, an aqueous dye ink, and an ultraviolet ray curing pigment ink that is cured by ultraviolet radiation.

A platen 13 is disposed below the carriage 35. The platen 13 extends in the main scanning direction Y. The recording medium 5 is placed on the platen 13. Pinching rollers 41 that press the top of the recording medium 5 downward are disposed above the platen 13. The platen 13 is provided with grit rollers 42. The grit rollers 42 are disposed below the pinching rollers 41. The grit rollers 42 are disposed at positions facing the pinching rollers 41. The grit rollers 42 are coupled to a feed motor 43. The grit rollers 42 are rotatable by a driving force of the feed motor 43. When the grit rollers 42 rotate with the recording medium 5 sandwiched between the pinching rollers 41 and the grit rollers 42, the recording medium 5 is conveyed in the subscanning direction X. The pinching rollers 41, the grit rollers 42, and the feed motor 43 define a conveying device 40 that conveys the recording medium 5 in the subscanning direction X.

FIG. 3 is a schematic front view of the cleaning device 50. The cleaning device 50 is configured to clean the ink heads H in a state where the carriage 35 is moved to a predetermined cleaning position P1. As illustrated in FIG. 2, in this preferred embodiment, the cleaning position P1 is near the right end of the printer 10. The cleaning position P1 is not limited to a specific position. As illustrated in FIG. 3, in this preferred embodiment, the cleaning device 50 includes a capping device 51 and a wiping device 55. The capping device 51 protects the ink heads H and sucks ink from the nozzles of the ink heads H. The suction of ink is one method of cleaning the ink heads H. As illustrated in FIG. 3, the capping device 51 includes a cap 52, a cap mover 53, and a suction pump 54. The cap 52 is attachable to the ink heads H. The cap mover 53 moves the cap 52 upward and downward so that the gap 52 is attached to or detached from the ink heads H. The suction pump 54 reduces the pressure in the cap 52 with the cap 52 attached to the ink heads H so that the suction pump 54 thereby sucks ink in the nozzles.

As illustrated in FIG. 3, the wiping device 55 includes a wiper 56 and a wiper mover 57. During non-wiping, the wiper 56 is disposed rearward of the carriage 35. The wiper 56 has a flat-plate shape extending in the main scanning direction Y and in the up-down direction. The wiper 56 is made of, for example, rubber. The wiper mover 57 moves the wiper 56 in the subscanning direction X so that the wiper 56 is brought into contact with the nozzle surface of the ink heads H. The nozzle surface of the ink heads H is wiped by the wiper 56 that moves in the subscanning direction X. The wiping is one method of cleaning the ink heads H. The wiping device 55 is not limited to the structure described above. The wiping may be performed while the ink heads H are proceeding in the main scanning direction Y by moving the carriage 35, for example. The cleaning of the ink heads H is not limited to the ink suction and the wiping.

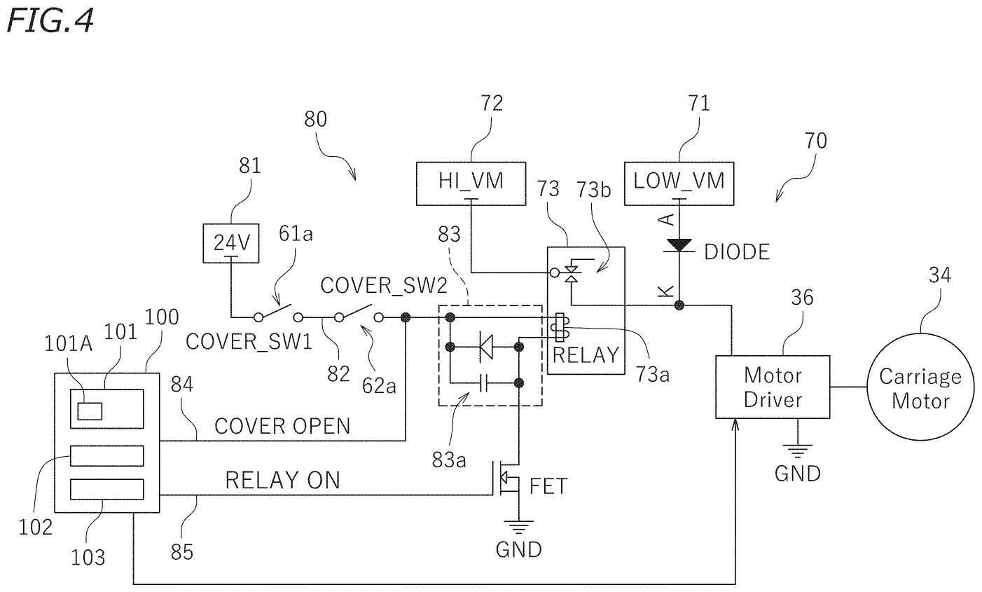

As illustrated in FIG. 2, a first switch 61 and a second switch 62 that detect opening/closing states of the first cover 21 and the second cover 22, respectively, are disposed in the casing 12. The first switch 61 detects the opening/closing state of the first cover 21. The second switch 62 detects the opening/closing state of the second cover 22. The first switch 61 is, for example, a mechanical limit switch. A mechanical contact point 61a (see FIG. 4) is disposed in the first switch 61, and when a movable member of the first switch 61 is pressed down, the contact point 61a is connected. The movable member of the first switch 61 is pressed by the first cover 21 when the first cover 21 is closed. This state where the contact point 61a of the first switch 61 is closed will be hereinafter referred to as “on” when necessary. On the other hand, the state where the contact point 61a of the first switch 61 is open will be referred to as “off.” The second switch 62 is also a similar mechanical switch in this preferred embodiment. In a manner similar to the first switch 61, the second switch 62 turns on when the second cover 22 is closed. The first switch 61 and the second switch 62 may be turned on when the first cover 21 and the second cover 22 are respectively opened, and turned off when the first cover 21 and the second cover 22 are closed, for example. The configurations of the first switch 61 and the second switch 62 are not specifically limited as long as the opening/closing states of the first cover 21 and the second cover can be respectively detected. The first switch 61 and the second switch 62 may be, for example, optical switches.

FIG. 4 is a circuit diagram concerning control of the carriage motor 34. As illustrated in FIG. 4, the carriage motor 34 is connected to the motor driver 36, and controlled by the motor driver 36. Control of the carriage motor 34 is performed with the motor driver 36. As illustrated in FIG. 4, the circuit for control of the carriage motor 34 includes, as well as the motor driver 36, a power supply circuit 70 that supplies electric power to the motor driver 36, an interlock circuit 80 that controls the motor driver through the power supply circuit 70, and a controller 100 configured or programmed to control operation of components of the printer 10 including the carriage motor 34.

As illustrated in FIG. 2, the controller 100 is housed in the casing 12. The controller 100 is electrically connected to the motor driver 36, the feed motor 43, actuators of the ink heads H, the cap mover 53 and the suction pump 54 of the capping device 51, and the wiper mover 57 of the wiping device 55 (whose connections are not shown except for connection to the motor driver 36), and is configured to control these components. As illustrated in FIG. 4, the controller 100 is also connected to the first switch 61 and the second switch 62 by a signal line 84.

The controller 100 is not limited to a specific configuration. The controller 100 is, for example, a microcomputer. The controller 100 is not limited to a specific hardware configuration, and includes, for example, an interface (I/F) that receives print data or others from an external device such as a host computer, a central processing unit (CPU) that executes an instruction of a control program, a read only memory (ROM) that stores a program to be executed by the CPU, a random access memory (RAM) that is used as a working area in which the program is expanded, and a storage such as a memory that stores the program and various types of data. The controller 100 does not need to be disposed inside the printer body 10a, and may be, for example, a computer disposed outside the printer body 10a and communicably connected to the printer body 10a by wires or wirelessly.

As illustrated in FIG. 4, the controller 100 is configured or programmed to include a movement controller 101, a cleaning controller 102, and a mode setter 103. The movement controller 101 controls driving of the carriage motor 34 with the motor driver 36. The movement controller 101 includes a braking controller 101A that controls the motor driver 36 under a predetermined interlock state to decelerate the carriage 35. Interlock conditions and operation of the carriage 35 under this interlock state will be described later. The cleaning controller 102 performs ink suction by controlling the cap mover 53 and the suction pump 54 of the capping device 51, and performs wiping by controlling the wiper mover 57 of the wiping device 55 in this preferred embodiment. The mode setter 103 can switch various modes concerning operation of the printer 10. In this preferred embodiment, the mode setter 103 can switch the mode of the printer among a plurality of modes including a printing mode and a cleaning mode. In the printing mode, printing is performed on the recording medium 5 by controlling the carriage motor 34, the feed motor 43, and the ink heads H. In the cleaning mode, the ink heads H are cleaned by controlling the cleaning device 50 by controlling the cap mover 53, the suction pump 54, and the wiper mover 57 of the cleaning device 50 in this preferred embodiment. The controller 100 may include other controllers, which are not described here and not shown.

The carriage 35 is moved at high speed in the printing mode and moved at low speed in the cleaning mode, where control thereof will be described in detail later. A mode in which the carriage 35 can move at high speed will be hereinafter referred to as a “high-speed mode” and a mode in which the carriage 35 can move only at low speed (i.e., the carriage 35 cannot move at high speed) will be hereinafter referred to as a “low-speed mode.” The high-speed mode includes the printing mode. The low-speed mode includes the cleaning mode. The low-speed mode may include, as well as the cleaning mode, an operation of moving the carriage 35 to measure the width of the main scanning direction Y of the recording medium 5 before printing starts, for example. In this case, the carriage 35 may be provided with, for example, a camera that can identify an end of the recording medium 5. An operation included in the low-speed mode and an operation included in the high-speed mode are not specifically limited. The mode setter 103 can switch the mode of the printer 10 between the high-speed mode and the low-speed mode.

The power supply circuit 70 switches a voltage to be applied to the motor driver 36. In this preferred embodiment, the voltage to be applied to the motor driver 36 by the power supply circuit 70 includes two types of voltage: a first voltage for low speed and a second voltage for high speed. The power supply circuit 70 selectively applies the first voltage or the second voltage higher than the first voltage to the motor driver 36. The power supply circuit 70 only needs to apply at least the first voltage and the second voltage to the motor driver 36, and may apply a third voltage to the motor driver 36, for example. The first voltage is not specifically limited, and may be, for example, about 5 V to about 15 V. A speed at which the carriage 35 can travel by applying the first voltage to the motor driver 36 will also be referred to as a “first speed.” The first voltage is a voltage at which the motor driver 36 can move the carriage 35 at the first speed with the carriage motor 34. The first speed is not specifically limited, either, and may be, for example, about 0.1 m/second to about 0.5 m/second.

Similarly, a speed at which the carriage 35 can travel by applying the second voltage to the motor driver 36 will also be referred to as a “second speed.” The second voltage is a voltage at which the motor driver 36 can move the carriage 35 at the second speed with the carriage motor 34. The second speed is not specifically limited, either, and may be, for example, about 1 m/second to about 2 m/second. The second voltage is not specifically limited, and may be, for example, about 30 V to about 50 V.

As illustrated in FIG. 4, the power supply circuit 70 includes a first power supply 71, a second power supply 72, and a relay 73 that selectively connects the first power supply 71 or the second power supply 72 to the motor driver 36. The first power supply 71 generates the first voltage. The second power supply 72 generates the second voltage. The first power supply 71 and the second power supply 72 are switching power supplies that can convert a commercial alternating current (AC) to a direct current (DC) at a necessary voltage. The first power supply 71 and the second power supply 72 are not limited to the switching power supplies.

As illustrated in FIG. 4, the relay 73 includes a coil 73a and a contact point 73b. The relay 73 connects the second power supply 72 to the motor driver 36 while the coil 73a is energized, and connects the first power supply 71 to the motor driver 36 while the coil 73a is not energized. In other words, while the coil 73a is energized, the second voltage for high speed is applied to the motor driver 36. At this time, the carriage 35 can be moved at the second speed, which is high. While the coil 73a is not energized, the first voltage for low speed is applied to the motor driver 36. The moving speed of the carriage 35 at this time is restricted to the first speed, which is low. When the coil 73a is energized and the coil 73a is excited, the contact point 73b moves to connect the second power supply 72 to the motor driver 36. Accordingly, the first power supply 71 and the motor driver 36 are substantially disconnected by a diode provided between the first power supply 71 and the motor driver 36. The relay 73 is not limited to this configuration. The relay 73 may be, for example, a two-contact point relay in which a contact point is connected to the first power supply 71 or the second power supply 72 depending on whether the coil is energized or not.

The interlock circuit 80 transmits a control signal for movement of the carriage 35 when a predetermined interlock condition is satisfied. Specifically, when the predetermined interlock condition is satisfied, the interlock circuit 80 shuts off energization to the coil 73a so that the carriage 35 is restricted to low-speed movement. In this preferred embodiment, stop of energization to the coil 73a is the control signal transmitted by the interlock circuit 80 to control the movement of the carriage 35. The “transmission of a control signal” for movement of the carriage 35 includes a reverse operation of signal transmission, that is, “stop of a signal.” In a case where the power supply circuit 70 is configured to perform a reverse operation to that in this preferred embodiment, for example, the control signal for movement of the carriage 35 may be start of energization to the coil 73a of the relay 73.

As illustrated in FIG. 4, the interlock circuit 80 includes a third power supply 81, a control circuit 82 interposed between the third power supply 81 and the coil 73a, and a delay circuit 83 provided in the control circuit 82. The third power supply 81 is a control power supply configured to enable excitation of the coil 73a. The third power supply 81 generates a DC voltage of 24 V for control in this preferred embodiment. The voltage generated by the third power supply 81 is not specifically limited. The control circuit 82 connects the third power supply 81 to the coil 73a. As illustrated in FIG. 4, the contact point 61a of the first switch 61 and the contact point 62a of the second switch 62 are connected in series in the control circuit 82.

The control circuit 82 is shut off when the predetermined interlock condition is satisfied. As illustrated in FIG. 4, in this preferred embodiment, the predetermined interlock condition is that at least one of the contact point 61a of the first switch 61 and the contact point 62a of the second switch 62 is opened. In other words, a state where at least one of the first cover 21 and the second cover 22 is opened and at least one of the first switch 61 and the second switch 62 turns off, this state corresponds to the predetermined interlock condition. The interlock circuit 80 includes the first switch 61 and the second switch 62 that detect the opening/closing states of the first cover and the second cover 22, respectively, and is shut off (transmits a control signal) when the first switch 61 and the second switch 62 detect that at least one of the first cover 21 and the second cover 22 is opened. Accordingly, energization to the coil 73a is stopped, and the motor driver 36 and the first power supply 71 are connected to each other. In a state where at least the interlock circuit 80 is shut off (i.e., the interlock circuit 80 transmits a control signal), the power supply circuit 70 applies the first voltage for low speed to the motor driver 36. In some cases, the power supply circuit 70 applies the first voltage to the motor driver 36 in a state where the predetermined interlock condition is not satisfied. This case will be described later.

The term “predetermined interlock condition” as used in this preferred embodiment is a control condition for restricting the moving speed of the carriage 35 to the first speed, and is a predetermined condition (where at least one of the first switch 61 and the second switch 62 is turned off in this preferred embodiment). The same holds for the terms such as “interlock circuit” and “interlock operation.”

As illustrated in FIG. 4, in this preferred embodiment, the interlock circuit 80 includes the delay circuit 83 that transmits a control signal (stops power supply to the coil 73a in this preferred embodiment) after a lapse of a predetermined delay time from when the predetermined interlock condition is satisfied. Thus, if a voltage applied to the motor driver 36 before the interlock condition is satisfied is the second voltage, the voltage applied to the motor driver 36 switches from the second voltage to the first voltage after a lapse of the predetermined delay time from when the interlock condition is satisfied.

As illustrated in FIG. 4, the delay circuit 83 includes a capacitor 83a that is charged when the control circuit 82 is connected and that discharges to the coil 73a when the control circuit 82 is disconnected. When both the first switch 61 and the second switch 62 are on and electric power is supplied to the coil 73a from the third power supply 81, a voltage generated by the third power supply 81 is also applied to the capacitor 83a. Accordingly, at this time, the capacitor 83a is charged in accordance with a capacitance. When at least one of the first switch 61 and the second switch 62 is turned off with the capacitor 83a being charged, the capacitor 83a starts discharging. During this discharging, a current due to the discharge of the capacitor 83a flows in the coil 73a. While the voltage at this time is an operating voltage of the relay 73 or more, the relay 73 is kept on. Consequently, switching of the voltage applied to the motor driver 36 is delayed. The capacitor 83a here is, for example, a large-capacity capacitor having a capacitance of about 1000 pF.

When at least one of the first switch 61 and the second switch 62 is turned off, this turn-off is transferred to the controller 100. As illustrated in FIG. 4, the circuit to control the carriage motor 34 includes the signal line 84 through which a signal is transmitted to the controller 100 when at least one of the first switch 61 and the second switch 62 is turned off. If the interlock condition is satisfied while the second voltage is applied to the motor driver 36 and the carriage 35 moves, the braking controller 101A of the controller 100 controls the motor driver 36 before the delay time described above has elapsed to thereby decelerate the carriage 35. In this preferred embodiment, the braking controller 101A controls the motor driver 36 to thereby stop the carriage 35 before the delay time ends.

The circuit to control the carriage motor 34 includes a driving line 85 used for the controller 100 to turn the relay 73 on and off. The driving line 85 connects the controller 100 to the coil 73a of the relay 73. The circuit to control the carriage motor 34 is configured such that while the driving line 85 is disconnected, no electric power is supplied to the relay 73 even if the control circuit 82 is connected. The controller 100 controls the voltage applied to the motor driver 36 by controlling an operation of the relay 73 through the driving line 85. Specifically, in the low-speed mode or while a control signal is transmitted, the controller 100 connects the motor driver 36 to the first power supply 71 by controlling an operation of the relay 73. In a high-speed mode (except for while a control signal is transmitted), the controller 100 connects the motor driver 36 to the second power supply 72 by controlling an operation of the relay 73. Consequently, in the low-speed mode or while the control signal is transmitted, the power supply circuit 70 applies the first voltage to the motor driver 36, whereas while an interlock signal is not transmitted in the high-speed mode, the power supply circuit 70 applies the second voltage to the motor driver 36. In this preferred embodiment, once a control signal is transmitted, an interlock state continues until a predetermined confirmation process is finished in the controller 100 even after the first cover 21 and the second cover 22 are closed. While the interlock state continues, the controller 100 disconnects the driving line 85. While the interlock state is canceled and the mode is the high-speed mode, the controller 100 connects the driving line 85 again.

The configuration of the circuit illustrated in FIG. 4 is an example, and the circuit concerning control of the carriage motor 34 is not limited to this example. The interlock circuit 80 is preferably basically defined by hardware, but may be partially defined by software. The types of devices to be used are not limited to a mechanical switch and a contact point relay, for example.

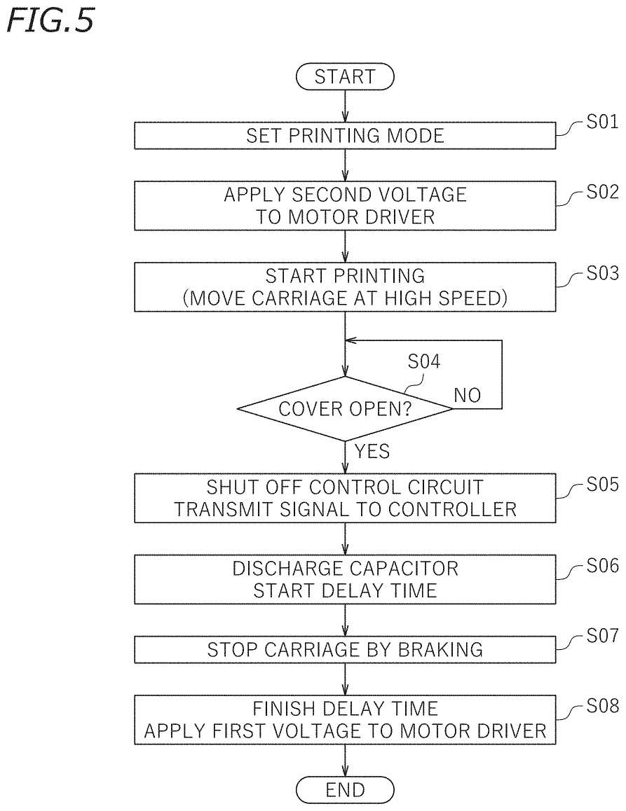

An operation of the printer 10 according to this preferred embodiment will now be described. FIG. 5 is a flowchart showing control of the carriage 35 in the high-speed mode. With reference to FIG. 5, an example of operation of the printer 10 in the high-speed mode, more specifically in the printing mode, will be described. As illustrated in FIG. 5, to execute printing, first, the mode is set in the printing mode in step S01. The other steps for starting printing are not shown in FIG. 5, and description thereof will be omitted. In step S02, the second power supply 72 is connected to the motor driver 36, and the second voltage for high speed is applied to the motor driver 36. In subsequent step S03, printing is started, and the carriage 35 moves in the main scanning direction Y by driving the carriage motor 34. At this time, the carriage 35 can move at a second speed.

In step S04, it is confirmed whether the first cover 21 and the second cover 22 are closed or not (in practice, it is sufficient to respond when at least one of the first cover 21 and the second cover 22 is opened, but FIG. 5 shows the step S04 as a confirmation step, for convenience). If the first cover 21 and the second cover 22 are closed (NO in step S04), the carriage 35 continues to move. If at least one of the first cover 21 and the second cover 22 is open (YES in step S04), in step 505, the control circuit 82 is shut off and this shut-off is transmitted to the controller 100 through the signal line 84.

In step S06, the capacitor 83a of the delay circuit 83 starts discharge to the relay 73. Accordingly, the delay time starts. In next step S07, in response to an instruction from the braking controller 101A of the controller 100, the carriage motor 34 is stopped by braking. At this time, delay by the delay circuit 83 continues application of the second voltage for high speed to the motor driver 36. Thus, the motor driver 36 can brake the carriage motor 34 with a stronger braking force. Thereafter, the delay time ends in step S08, and the first power supply 71 is connected to the motor driver 36. Accordingly, the first voltage is applied to the motor driver 36.

As described above, in this preferred embodiment, when the interlock condition is satisfied while the carriage 35 is moving in the high-speed mode, the carriage 35 is stopped by braking, and the voltage applied to the motor driver 36 is switched to the first voltage for low speed. This is because the low-speed mode is a basic mode in this preferred embodiment. In this preferred embodiment, except for cases where the carriage 35 needs to move at high speed, such as the case of printing, the mode is set in the low-speed mode. However, to stop the carriage 35 in a shorter time, during the delay time, the voltage applied to the motor driver 36 is kept at the second voltage for high speed, and the carriage motor 34 is stopped with a braking force of the second voltage.

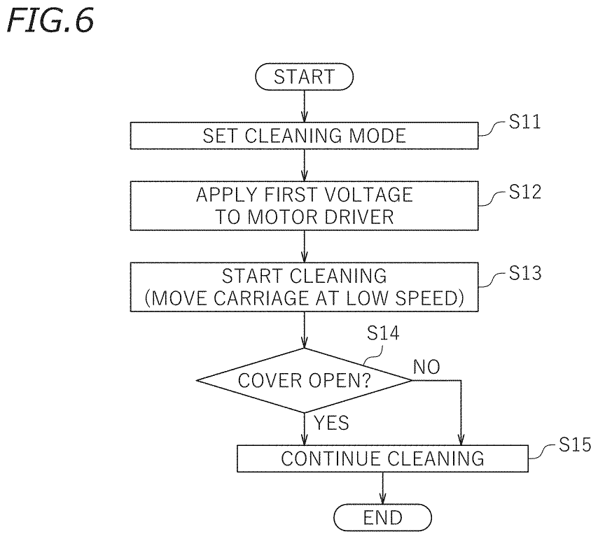

Next, control of the carriage 35 in the low-speed mode will be described. FIG. 6 is a flowchart showing control of the carriage 35 in the low-speed mode. With reference to FIG. 6, an example of operation of the printer 10 in the low-speed mode, more specifically in the cleaning mode, will be described. As illustrated in FIG. 6, to execute cleaning of the ink heads H, first, in step S11, the mode is set in the cleaning mode. In step S12, the first power supply 71 is connected to the motor driver 36, and the first voltage for low speed is applied to the motor driver 36. In subsequent step S13, cleaning is started, and the carriage 35 moves to the cleaning position P1 (see FIG. 2) by driving the carriage motor 34. At this time, the carriage 35 can move at a first speed.

Although not shown, in cleaning of the ink heads H, suction of ink by the capping device 51 and wiping by the wiping device 55 are performed. The carriage 35 needs to move in the main scanning direction Y between the ink suction and the wiping. After cleaning is finished, the cap 52 is attached to the ink heads H for protection. At this time, the carriage 35 needs to move to a position immediately above the capping device 51.

In step S14, opening/closing states of the first cover 21 and the second cover 22 are determined. As illustrated in FIG. 6, in the low-speed mode, irrespective of whether the first cover 21 and the second cover 22 are closed or not (in either case of YES or NO in step S14), cleaning (movement of the carriage 35) continues in step S15. In the low-speed mode, determination on whether the first cover 21 and the second cover 22 are closed or not in step S14 may not be performed.

Advantages of this preferred embodiment will now be described. The printer 10 according to this preferred embodiment includes the power supply circuit 70 that selectively applies either the first voltage for low-speed movement of the carriage 35 or the second voltage for high-speed movement of the carriage 35 to the motor driver 36, and the interlock circuit 80 that transmits a control signal to control the carriage 35 when the predetermined interlock condition is satisfied. In the state where the interlock circuit 80 transmits the control signal, the power supply circuit 70 applies the first voltage for low speed to the motor driver 36. With this configuration, even in the state where the predetermined interlock condition is satisfied and the interlock circuit 80 transmits the control signal, the first voltage is applied to the motor driver 36. Thus, the carriage 35 can be moved at the first speed, which is low.

In a conventional printer, in a state where a casing is uncovered, for example, a carriage cannot be moved for safety of a user. However, even in such a situation, for example, a user wants to move the carriage in an uncovered state in some cases. Specifically, the user wants to visually observe movement of the carriage in an uncovered state, for example. In such a case, in the printer 10 according to this preferred embodiment, as illustrated in FIG. 6, for example, the carriage 35 can move in the low-speed mode. Since the first speed that is the speed of the carriage 35 in the low-speed mode is relatively low, movement of the carriage 35 will not cause any safety problems. Thus, the printer 10 can satisfy both safety and convenience under the predetermined interlock conditions.

For example, in this preferred embodiment, the power supply circuit 70 applies the first voltage to the motor driver 36 in the state where the mode is the low-speed mode or the interlock signal is transmitted, whereas the power supply circuit 70 applies the second voltage to the motor driver 36 in the state where no interlock signal is transmitted in the high-speed mode. The low-speed mode includes the cleaning mode, and the high-speed mode includes the printing mode. With this configuration, for example, in cleaning performed while the printer 10 is not used (e.g., at night), even when the first cover 21 or the second cover 22 is unintentionally opened, cleaning can be performed. It is also possible to observe the state of cleaning by opening the first cover 21 or the second cover 22. The printing mode is included in the high-speed mode, and printing can be performed with the carriage 35 being moved at the second speed.

In this preferred embodiment, the power supply circuit 70 includes the first power supply 71 that generates the first voltage, the second power supply 72 that generates the second voltage, and the relay 73 that includes the coil 73a and connects the second power supply 72 to the motor driver 36 when the coil 73a is energized and connects the first power supply 71 to the motor driver 36 when the coil 73a is not energized. With this configuration, even if energization to the relay 73 is stopped because of, for example, a failure of the printer 10, the first power supply 71 is connected to the motor driver 36. Thus, in this case, the moving speed of the carriage motor 34 is restricted to the first speed. Thus, safety of the printer 10 can be further enhanced.

In this preferred embodiment, the interlock circuit 80 includes the delay circuit 83 that transmits a control signal after a lapse of the predetermined delay time from when the interlock condition is satisfied. In a case where the interlock condition is satisfied while the second voltage is applied to the motor driver 36 and the carriage 35 moves, the braking controller 101A of the controller 100 controls the motor driver 36 before the delay time has elapsed to decelerate the carriage 35. With this configuration, since the second voltage for high speed is applied to the motor driver 36 in the delay time, the carriage 35 can be decelerated with a stronger braking force. Thus, the carriage 35 can be stopped in a shorter time. Accordingly, safety in high-speed movement of the carriage 35 can be further enhanced.

The delay circuit 83 includes the capacitor 83a that is charged while the control circuit 82 is connected and discharges to the coil 73a of the relay 73 when the control circuit 82 is disconnected. With the presence of the capacitor 83a, the delay circuit 83 can easily and reliably delays switching of the voltage applied to the motor driver 36.

In this preferred embodiment, the interlock circuit 80 includes the first switch 61 and the second switch 62 that detect the opening/closing states of the first cover 21 and the second cover 22, respectively, and transmits a control signal when it is detected that at least one of the first cover 21 and the second cover 22 is opened. With this configuration, when the first cover 21 or the second cover 22 is opened, at least the speed of the carriage 35 is restricted to the first speed (in some situations, the carriage 35 is stopped). Thus, safety of the printer 10 can be obtained.

### Other Preferred Embodiments

The foregoing description is directed to the preferred embodiments of the present invention. The preferred embodiments described above, however, are merely examples, and the present invention can be performed in various modes, combinations and modifications of preferred embodiments.

For example, in the preferred embodiments described above, the condition for transmitting a control signal is that at least one of the first cover 21 and the second cover 22 is open, but other conditions may be used. The condition for transmitting a control signal may include a user operation such as pressing of an emergency stop button, or may include abnormality detection of any portion of the printer 10, for example.

In the preferred embodiments described above, the carriage 35 moves in the main scanning direction Y and the recording medium 5 moves in the subscanning direction X, but the present invention is not limited to the preferred embodiments described above. The carriage 35 and the recording medium 5 move relative to each other, and any one of the carriage 35 and the recording medium 5 may move in the main scanning direction Y or in the subscanning direction X. For example, the recording medium 5 may be disposed to be non-movable with the carriage 35 movable in the main scanning direction Y and in the subscanning direction X. The printer 10 may also be configured such that both the carriage 35 and the recording medium 5 are movable in the main scanning direction Y and in the subscanning direction X.

Ink discharge systems according to preferred embodiments of the present invention are not limited to those described above. An ink discharge system of a printer according to a preferred embodiment of the present invention may be a piezoelectric system using a piezoelectric element, various continuous systems such as a binary deflection system or a continuous deflection system, or various on-demand systems such as a thermal system, for example.

The techniques disclosed herein are applicable to various types of printers. The techniques disclosed herein are also applicable to a flat-bed type printer, for example, as well as a so-called roll-to-roll printer described in the preferred embodiments. The techniques disclosed herein is also applicable to an apparatus combining a printer and other devices. For example, the techniques disclosed herein are applicable to a printer with a cutting head or a printer with a sheet cutter. The techniques disclosed herein are also applicable to a three-dimensional printer or a cutting device with a carriage. In such a case, an operation in a high-speed mode may include cutting, sheet cutting, and/or discharge of a curing solution, for example.

The terms and expressions used herein are for description only and are not to be interpreted in a limited sense. These terms and expressions should be recognized as not excluding any equivalents to the elements shown and described herein and as allowing any modification encompassed in the scope of the claims. The present invention may be embodied in many various forms. This disclosure should be regarded as providing preferred embodiments of the principles of the present invention. These preferred embodiments are provided with the understanding that they are not intended to limit the present invention to the preferred embodiments described in the specification and/or shown in the drawings. The present invention is not limited to the preferred embodiments described herein. The present invention encompasses any of preferred embodiments including equivalent elements, modifications, deletions, combinations, improvements and/or alterations which can be recognized by a person of ordinary skill in the art based on the disclosure. The elements of each claim should be interpreted broadly based on the terms used in the claim, and should not be limited to any of the preferred embodiments described in this specification or referred to during the prosecution of the present application.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A printing apparatus comprising:
a carriage;
a carriage mover including a motor to move the carriage;
a motor controller to control the motor;
a power supply to selectively apply a first voltage or a second voltage to the motor controller, the second voltage being higher than the first voltage; and
a transmitter to transmit a control signal for movement of the carriage when a predetermined control condition is satisfied; wherein
the first voltage is a voltage enabling the motor controller to move the carriage at a first speed by the motor;
the second voltage is a voltage enabling the motor controller to move the carriage at a second speed by the motor, the second speed being higher than the first speed; and
the power supply is operable to apply the first voltage to the motor controller in a state where the transmitter transmits the control signal.

2. The printing apparatus according to claim 1, further comprising:
an ink head held by the carriage;
a cleaner to clean the ink head in a state where the carriage is moved to a predetermined cleaning position; and
a mode setter to switch a mode between a low-speed mode and a high-speed mode, the low-speed mode including a cleaning mode in which the cleaner cleans the ink head, the high-speed mode including a printing mode; wherein
the power supply is operable to apply the first voltage to the motor controller in the low-speed mode, and to apply the second voltage to the motor controller in a state where the control signal is not transmitted in the high-speed mode.

3. The printing apparatus according to claim 1, further comprising:
a housing to house the carriage; and
a cover on the housing, the cover being openable and closable; wherein
the transmitter includes a detector to detect an opening/closing state of the cover, and when the detector detects that the cover is opened, the transmitter transmits the control signal.

4. The printing apparatus according to claim 1, wherein the power supply includes:
a first power supply to generate the first voltage;
a second power supply to generate the second voltage; and
a relay including an exciter, the relay being operable to connect the second power supply to the motor controller while the exciter is energized, and to connect the first power supply to the motor controller while the exciter is not energized; and
the transmitter includes:
a third power supply to enable excitation of the exciter; and
a control circuit interposed between the third power supply and the exciter to be shut off when the control condition is satisfied.

5. The printing apparatus according to claim 1, wherein the transmitter includes a delay circuit to transmit the control signal after a predetermined delay time has elapsed from when the control condition is satisfied.

6. The printing apparatus according to claim 5, further comprising:
a brake to control the motor controller and decelerate the carriage before a lapse of the predetermined delay time in a case where the control condition is satisfied while the second voltage is applied to the motor controller and the carriage moves.

7. The printing apparatus according to claim 5, wherein the power supply includes:
a first power supply to generate the first voltage;
a second power supply to generate the second voltage; and
a relay including an exciter and operable to connect the second power supply to the motor controller while the exciter is energized, and to connect the first power supply to the motor controller while the exciter is not energized;
the transmitter includes:
a third power supply to enable excitation of the exciter; and
a control circuit interposed between the third power supply and the exciter to be shut off when the control condition is satisfied; and
the delay circuit includes a capacitor to be charged while the control circuit is connected, and to discharge to the exciter when the control circuit is disconnected.
